(19) United States
(12) Patent Application Publication
(10) Pub. No.: US 2022/0178615 A1
(43) Pub. Date: Jun. 9, 2022

(54) TAPHOLE PLUGGING GUN

(71) Applicant: TMT TAPPING MEASURING TECHNOLOGY SÀRL, Luxembourg (LU)

(72) Inventor: Franck MORELLATO, Arnaville (FR)

(21) Appl. No.: 17/438,226

(22) PCT Filed: Mar. 13, 2019
(86) PCT No.: PCT/EP2019/056261

§ 371 Date: Sep. 10, 2021

(51) Int. Cl. F27D 3/15; C21B 7/12

(52) U.S. Cl. CPC F27D 3/1536; C21B 7/12

(57) ABSTRACT

A tap hole plug gun comprising a material chamber for receiving a plugging compound, a mouthpiece for being introduced into a tap hole, and a nozzle part tapered in the direction of the mouthpiece and connected to the material chamber by means of an unlockable connection device. For realizing the connection device, the material chamber and the nozzle part have complementary axial connecting projections on two opposite axial connecting edges of a chamber wall of the material chamber and of a nozzle wall of the nozzle part.

This application represents the national stage entry of PCT International Application No. PCT/EP2019/056261 filed on Mar. 13, 2019, the entire contents of which is incorporated herein by reference for all purposes.

The disclosure relates to a tap hole plug gun comprising a material chamber for receiving a plugging compound, a mouthpiece for being introduced into a tap hole, and a nozzle part tapered in the direction of the mouthpiece and connected to the material chamber by means of an unlockable connection device.

Tap hole plug guns of the kind mentioned above are used to close the tap openings of reduction furnaces or smelting furnaces, such as blast furnaces for producing pig iron and low-shaft furnaces for smelting nonferrous metals, ferroalloys, etc. During plugging, the tap hole plug gun is pressed against the front of the furnace with great force by means of a pivoting device, the contact pressure being maintained until the plugging compound injected into the tap hole opening of the furnace through the mouthpiece of the tap hole plug gun has hardened.

To operate the tap hole plug gun, the plugging compound is received in a material chamber of the tap hole plug gun, which is typically a cylindrical space, and is injected from the material chamber into the tap hole opening through the mouthpiece of the tap hole plug gun by means of a plugging piston. A typically conical nozzle part connected to the material chamber by means of a connecting device in an exchangeable manner is disposed between the material chamber and the mouthpiece to reduce the diameter of the tap hole plug gun in the area of transition between the material chamber and the mouthpiece. Great forces act on the connection device during ejection because of the substantially reduced diameter in the section from the nozzle part to the mouthpiece, two essential requirements to be met by the connecting device being that the connection device has to be easy to detach for replacement of the nozzle part while being stable enough to reliably absorb the forces acting during ejection without impairing detachability.

WO 2011/089054 A1 discloses a tap hole plug gun having a nozzle part connected to the material chamber via a flange connection. The flange connection connects the nozzle part to the material chamber in a connection plane perpendicular to the ejecting direction, connecting bolts distributed across the circumference of the tap hole plug gun and extending parallel to the ejecting direction connecting two opposite flanges disposed on the material chamber and on the nozzle part so as to realize the flange connection. Since the connecting bolts extend parallel to the ejecting direction, their number and size have to be such that the ejection forces can be safely transmitted via the bolts without this endangering the sealing of the tap hole plug gun in the connection plane or there even being a risk of the components of the bolt connections failing.

The large number of bolt connections distributed across the circumference of the tap hole plug gun for realizing the flange connection results in a corresponding amount of installation work when exchanging the nozzle part, which might even be increased by the fact that a shielding device, which is typically disposed on the underside of the tap hole plug gun in order to shield the tap hole plug gun from heat radiation directed at the tap hole plug gun from a runner when the tap hole plug gun is in a working position, will have to be removed from the tap hole plug gun before the nozzle part is installed or removed in order to provide access to the bolt connections disposed in the area of the underside of the tap hole plug gun.

Hence, the object of the present disclosure is to propose a tap hole plug gun that has a connection device making a reliable mechanical connection between the material chamber and the nozzle part possible while allowing the nozzle part to be exchanged with relatively little installation effort.

To attain said object, the tap hole plug gun according to the disclosure has the features of claim 1.

For realizing the connection device, the material chamber and the nozzle part have complementary axial connection projections on two opposite axial connecting edges of a chamber wall of the material chamber and of a nozzle wall of the nozzle part in such a manner according to the disclosure that the connecting projection formed on an upper part of the nozzle part is disposed on the connecting projection formed on a lower part of the material chamber, a form-fitting radial engagement being established between the connecting projection of the nozzle part and the upper part of the material chamber and/or between the connecting projection of the material chamber and the lower part of the nozzle part, said form-fitting radial engagement being secured in a force-fitting manner by means of a radially acting securing device.

Realizing the connection device according to the disclosure allows the ejection forces acting on the connection device in a separating manner to be absorbed by the form fit established between the connecting projections, which means that the radially acting securing device is needed only for securing the connecting projections in their position on top of each other, without the securing device being needed to absorb the ejection forces. Instead, the securing device serves to secure the position of the connecting projections in a plane perpendicular to the ejecting direction. On the one hand, this means that there are no particular requirements in terms of the size of the securing device; on the other hand, the securing device can be disposed in such a manner that access exclusively from the top of the tap hole plug gun is sufficient.

Moreover, the design of the connection device allows the connection between the nozzle part and the material chamber to be established and severed via access to the connection device from the top of the tap hole plug gun, which means that a shielding device that may be disposed on the underside of the tap hole plug gun will not have to be removed in order to gain access to the connection device.

In conclusion, the connection device enables both a reliable mechanical connection between the material chamber and the nozzle part and facilitated installation when exchanging the nozzle part.

For realizing the form-fitting engagement, a ring segment web is formed on a connecting wall portion on the connecting projection of the nozzle part on the radial interior of the nozzle wall according to an advantageous embodiment, said ring segment web engaging into a ring segment groove formed on a connecting edge portion on the upper part of the material chamber on the radial exterior of the chamber wall, and/or a ring segment web is formed on a connecting edge portion on the lower part of the nozzle part on the radial exterior of the nozzle wall, said ring segment web engaging into a ring segment groove formed on a connecting edge portion on the connecting projection of the material chamber on the radial interior of the chamber wall.

The form-fitting engagement of this advantageous design allows the form-fitting engagement to be realized without any effect on the outer contour of the tap hole plug gun, which means that the surfaces in the area of transition between the nozzle part and the material chamber are essentially flush in particular on the underside of the tap hole plug gun, thus allowing a correspondingly close, radially adjacent disposition of a shielding device that may be disposed on the underside and consequently the disposition of a shielding device on the tap hole plug gun, without this substantially enlarging the exterior dimensions of the tap hole plug gun.

Moreover, the advantageous configuration of the form-fitting engagement as described above enables evenly distributed transmission of the connecting forces across the circumference and a correspondingly even sealing across the entire circumference by means of the engagement between a ring segment web and a ring segment groove.

Continuous distribution of the connecting forces across the entire circumference of the tap hole plug gun and of the connection device is ensured if each connecting edge portion of the nozzle part is provided with a ring segment web extending across essentially the entire length of the connecting edge portion and if each connecting edge portion of the material chamber is provided with a ring segment groove extending across essentially the entire length of the connecting edge portion.

Preferably, the radially inner ring segment groove formed in the connecting projection of the material chamber extends across a circumferential angle of >180° in such a manner that opposite ring segment groove ends extend vertically so as to form vertical guides for ends of the ring segment web formed on the connecting projection of the nozzle part, which means that the joining process during establishment of the form-fitting engagement is guided.

If the connecting projections are detachably connected to each other at opposite horizontal connecting edge portions for forming the securing device, the securing device can be realized with no more than two securing elements.

Preferably, the securing device has two bolt connections disposed on the circumference of the tap hole plug gun in the area of the horizontal connecting edge portions.

The bolt connections can be realized in a most simple way if the bolt connections serve to connect connecting tabs formed on the horizontal connecting edge portion of the nozzle part and on the horizontal connecting edge portion of the material chamber, respectively, in a force-fitting manner.

Preferably, each bolt connection has a bolt preferably realized as a threaded bolt and provided with a protective device disposed between the bolt and the mouthpiece and protecting the bolt against external influences, which means that the function and handling of the bolt connection cannot be adversely affected by external influences, such as metal or slag splattering from the tapping channel, which might lead to corresponding depositions on the bolt connection.

Particularly advantageously, at least one connecting tab of each bolt connection is provided with a protective web extending parallel to the bolt to realize the protective device.

Hereinafter, a preferred embodiment of the disclosure will be explained in more detail with reference to the drawing.

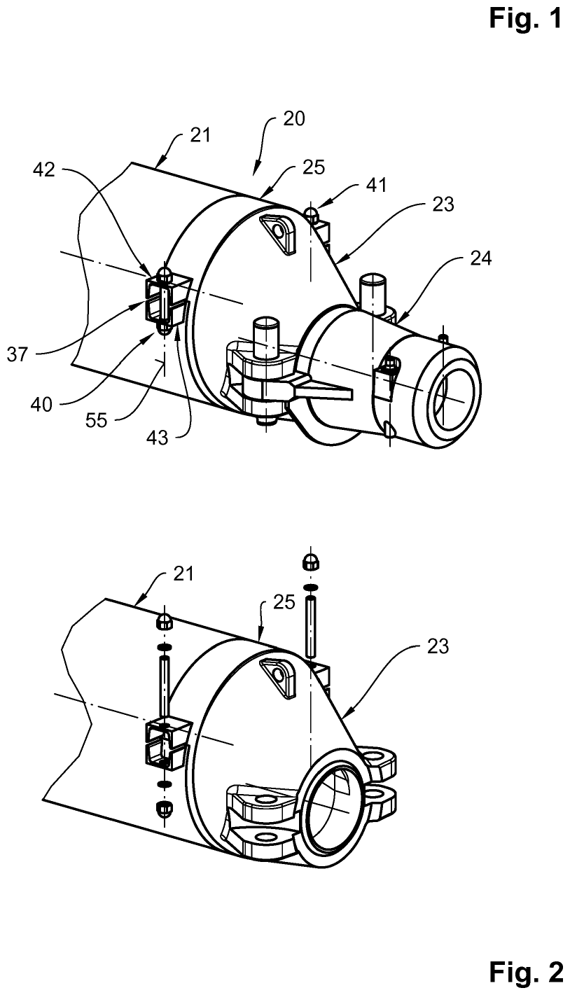

FIG. 1 is an isometric illustration of a tap hole plug gun comprising a nozzle part disposed between a material chamber and a mouthpiece;

FIG. 2 shows the tap hole plug gun of FIG. 1 with a mouthpiece removed from the nozzle part;

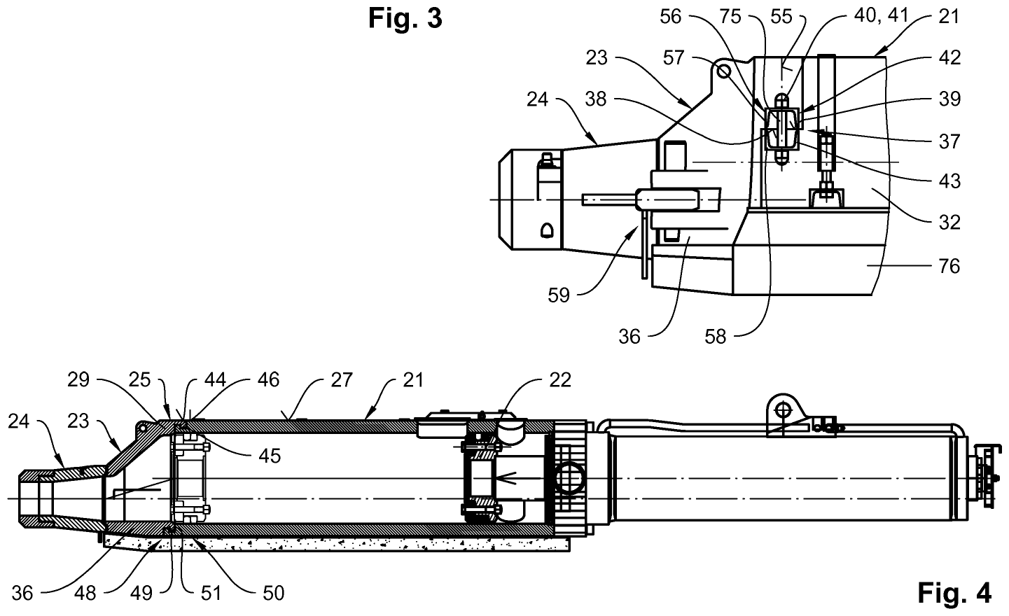

FIG. 3 is a partial side view of the tap hole plug gun illustrated in FIG. 1;

FIG. 4 is a longitudinal section view of the tap hole plug gun illustrated in FIG. 3;

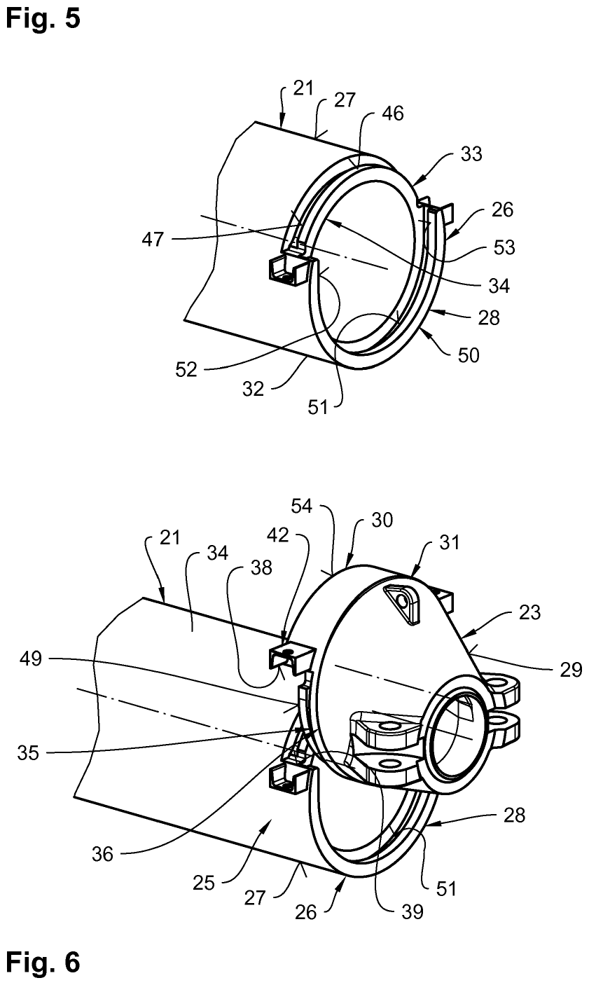

FIG. 5 is an isometric illustration of the material chamber with an axial connecting projection formed on the lower part of the material chamber;

FIG. 6 shows the material chamber of FIG. 5 with a nozzle part disposed in the installed position above the connecting projection;

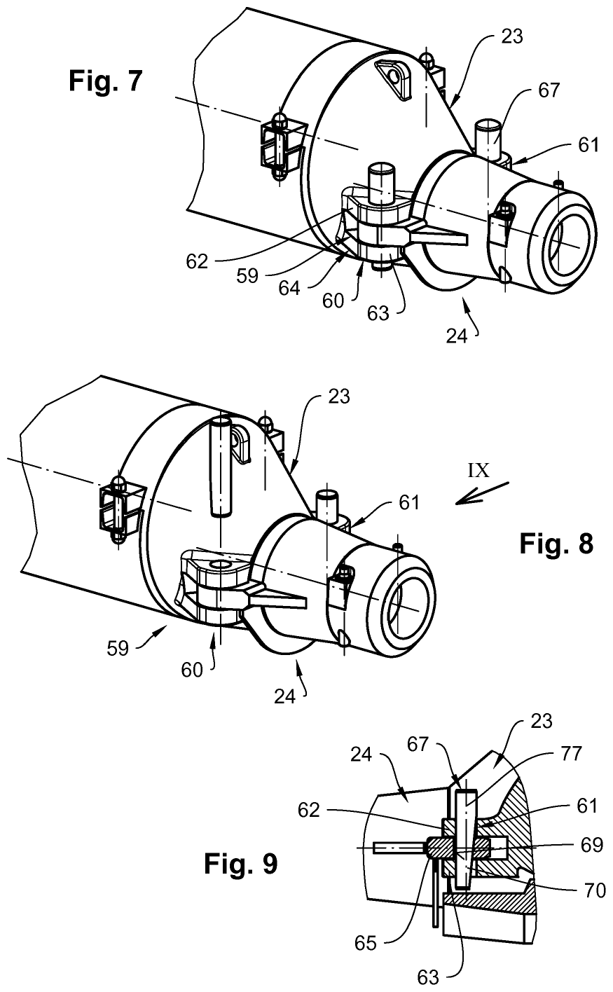

FIG. 7 shows the nozzle part of FIG. 1 with the mouthpiece connected to it via a hinged joint arrangement;

FIG. 8 shows the mouthpiece of FIG. 7 during an installation stage;

FIG. 9 is a side view of the mouthpiece illustrated in FIG. 8;

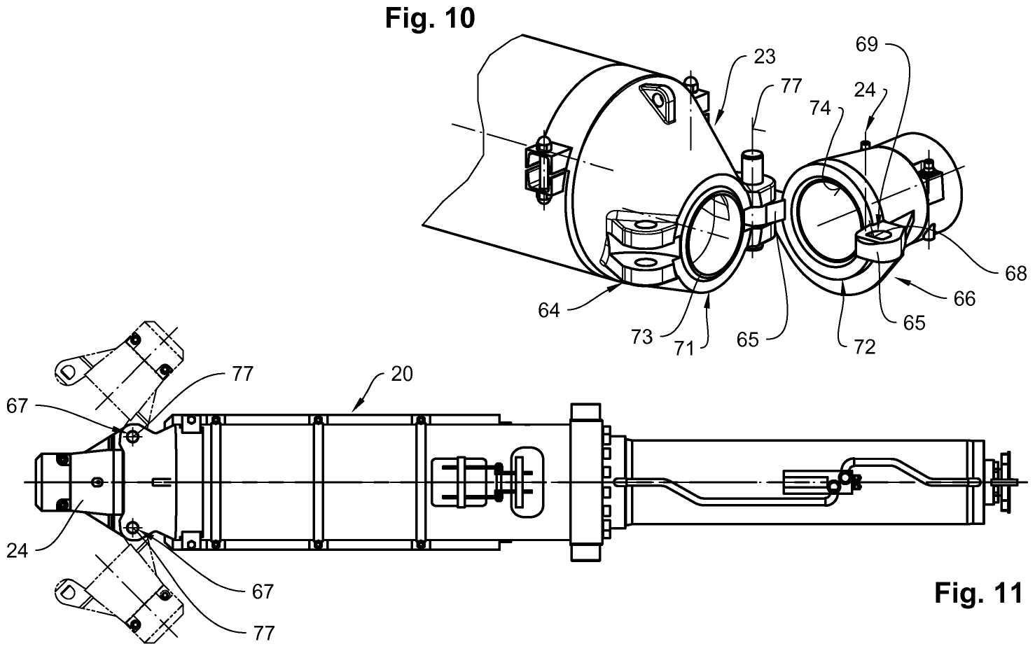

FIG. 10 shows the hinged joint arrangement of FIGS. 7 and 8 with a mouthpiece pivoted about a hinged joint;

FIG. 11 is a bottom view of the tap hole plug gun illustrated in FIG. 4.

FIG. 1 shows a tap hole plug gun 20 illustrated with its essential components, tap hole plug gun 20 comprising a material chamber 21 realized as a hollow cylinder as seen in particular from the illustration in FIG. 4, material chamber 21 serving to receive a plugging compound filled into material chamber 21 via a filling opening (not shown), compacted in material chamber 21 by means of a piston 22 guided in material chamber 21, and discharged into a tap hole of a furnace installation (not shown) from a mouthpiece 24 connected to material chamber 21 via a nozzle part 23, mouthpiece 24 being independent from nozzle part 23 in the embodiment of tap hole plug gun 20 at hand.

Nozzle part 23 enables a reduction of the inner diameter of tap hole plug gun 20 as required for the area of transition from material chamber 21 to mouthpiece 24, and for this purpose is truncated, in particular obliquely truncated in the exemplary embodiment at hand. As can be understood in particular from the illustration in FIG. 4, great axial forces resulting from the compression forces exerted on the plugging compound by piston 22 act on a connection device 25 formed between material chamber 21 and nozzle part 23 during compression of the plugging compound in material chamber 21 when tap hole plug gun 20 is in operation. As shown in FIG. 6, connection device 25 has an axial connecting projection 28 on an axial connecting edge 26 of a chamber wall 27 of material chamber 21 and a connecting projection 30 on an axial connecting edge 54 of a nozzle wall 29 of nozzle part 23 for establishing a form-fitting connection between material chamber 21 and nozzle part 23.

As becomes clear in particular from a combined view of FIGS. 5 and 6, connecting projection 30 of nozzle part 23 is formed on an upper part 31 of nozzle part 23 and connecting projection 28 of material chamber 21 is formed on a lower part 32 of material chamber 21, connecting projection 30 of nozzle part 23 thus resting on connecting projection 28 formed on material chamber 21, a form-fitting radial engagement being established between connecting projection 30 of nozzle part 23 and a connecting edge portion 33 on an upper part 34 of material chamber 21 on one side and between connecting projection 28 of material chamber 21 and a connecting edge portion 35 on a lower part 36 of nozzle part 23 on the other side.

As becomes clear from a comparison of FIGS. 6 and 2, which show nozzle part 23 in a relative position immediately prior to the establishment of the form-fitting engagement (FIG. 6) and in a relative position immediately after the establishment of the form-fitting engagement (FIG. 2), nozzle part 23 is already secured in its relative position in connection with material chamber 21 under the influence of gravity once the form-fitting engagement has been established. In order to also secure the relative position illustrated in FIG. 2 when compression forces are acting on nozzle part 23, a radially acting securing device 37 is provided in addition to the form-fitting engagement, said securing devices 37 having respective bolt connections 40, 41 (FIG. 1) on opposite horizontal connecting edge portions 38, 39 (FIG. 6), said bolt connections 40, 41 connecting two opposite connecting tabs 42 and 43 formed on connecting edge portion 38 of connecting projection 30 of nozzle part 23 and on connecting edge portion 39 of connecting projection 28 of material chamber 21, respectively, by means of a threaded bolt (not shown).

Hence, bolt connections 40, 41 secure connecting projections 28, 30 in their radial position, preventing compression forces occurring in tap hole plug gun 20 from severing the form-fitting engagement established between connecting projections 28, 30 and serving to absorb the axial portion of the compression forces.

For realizing the form-fitting engagement, a ring segment web 45 (FIG. 4) is formed on a connecting edge portion 44 on connecting projection 30 of nozzle part 23 on the radial interior of nozzle wall 29, said ring segment web 45 engaging into a ring web groove 47 (FIG. 5) formed on a connecting edge portion 46 on upper part 34 of material chamber 21 on the radial exterior of chamber wall 27.

As shown in FIG. 4, a ring segment web 49 is formed in a connecting edge portion 48 on lower part 36 of nozzle part 23 on the radial exterior of nozzle wall 29, said ring segment web 49 engaging into a ring segment groove 51 formed on a connecting edge portion 50 on connecting projection 28 of material chamber 21 on the radial interior of chamber wall 27.

As can be seen in particular from the illustration in FIG. 5, radially inner ring segment groove 51 formed in connecting projection 28 of material chamber 21 extends across a circumferential angle of >180° in such a manner that during establishment of the engagement, opposite groove ends 52, 53 of ring segment groove 51 can serve to form vertical guides for ends of ring segment web 45 which are formed on connecting projection 30 of nozzle part 23 and accordingly extend in the vertical direction.

As can be seen in particular from FIG. 3, bolt connections 40, 41 are configured in such a manner that a bolt that connects connecting tabs 42, 43 in a force-fitting manner along a bolt axis 55 and is preferably realized as a threaded bolt 75 is protected against external influences on the side facing the mouthpiece 24 by a protective device 56 formed by protective webs 57, 58 realized vertically on connecting tabs 42 and simultaneously enabling flexural rigidity of connecting tabs 42.

A shielding device 76 is disposed on lower part 32 of material chamber 21 and on lower part 36 of nozzle part 23, in particular for protection against heat radiation emitted against tap hole plug gun 20 below tap hole plug gun 20.

As can be seen in particular from the sequence of FIGS. 7 to 10, mouthpiece 24 is realized as a component that is independent from nozzle part 23 in the case at hand, a hinged joint arrangement 59 being provided for connecting mouthpiece 24 to nozzle part 23, hinged joint arrangement 59 having two opposite hinged joints 60, 61 each having a joint plate arrangement 64 composed of two parallel joint plates 62, 63 and a joint plate arrangement 66 of nozzle part 23 formed by a single joint plate 65, both joint plate arrangements 64, 65 being connected via a joint bolt 67.

As shown in FIG. 10, joint plate 65 disposed on mouthpiece 24 has a jamb portion 68 of a joint eyelet 69, said jamb portion 68 being wedge-shaped in the direction of a joint axis 77 and having a wedge shape complementary to a wedge portion 70 (FIG. 9) of joint bolt 67 in such a manner that when joint bolt 67 is disposed in hinged joints 60, 61, joint bolt 67 connects joint plate arrangement 64 of nozzle part 63 to joint plate 65 of mouthpiece 24, as shown in FIG. 7, in such a manner that wedge portion 70 is disposed in joint eyelet 69 of joint plate 65 and is connected to joint plate 65 in a non-rotating manner.

In the configuration illustrated in FIG. 7, both opposite hinged joints 60, 61 are provided with joint bolt 67 for forming joint axis 77, which means that mouthpiece 24 is fixated relative to nozzle part 23 and can be introduced into the tap hole by an advancing movement of tap hole plug gun 20, if required.

In the event that one of the two joint bolts 67 is removed from one of hinged joints 60 or 61, mouthpiece 24 can pivot on one side about joint axis 77, which is formed by joint bolt 67 remaining in hinged joint 60 or 61, for maintenance purposes, for example. Thus, as illustrated in FIG. 11, mouthpiece 24 can selectively pivot about a joint axis 77 in one direction or the other.

As can be seen from FIG. 10, an engagement device is formed between opposite axial connecting edges 71 and 72 of nozzle part 23 and of mouthpiece 24, respectively, said engagement device being composed of a ring web 73 formed on connecting edge 71 of nozzle part 23 on one side and of a ring groove 74 formed on connecting edge 72 of mouthpiece 24 on the other side and enabling radial sealing of the connection established between nozzle part 23 and mouthpiece 24 by hinged joint arrangement 59.

Preferably, ring web 73 has a truncated cross-section that is complementary to the cross-section of ring groove 74. The wedge effect made possible between jamb portions 68 of joint plates 65 and wedge portions 70 of joint bolts 67 can generate an axial sealing force between nozzle part 23 and mouthpiece 24 by inserting joint bolts 67 into joint eyelets 69 of joint plates 65, an effectively sealing position of mouthpiece 24 and nozzle part 23 relative to each other being achieved by means of said axial sealing force.

1. A tap hole plug gun comprising a material chamber for receiving a plugging compound, a mouthpiece for being introduced into a tap hole, and a nozzle part tapered in the direction of the mouthpiece and connected to the material chamber by means of an unlockable connection device,
wherein
for realizing the connection device, the material chamber and the nozzle part have complementary axial connecting projections on two opposite axial connecting edges of a chamber wall of the material chamber and of a nozzle wall of the nozzle part in such a manner that the connecting projection formed on an upper part of the nozzle part is disposed on the connecting projection formed on a lower part of the material chamber, a form-fitting radial engagement being established between the connecting projection of the nozzle part and the upper part of the material chamber and/or between the connecting projection of the material chamber and the lower part of the nozzle part, said form-fitting radial engagement being secured in a force-fitting manner by means of a radially acting securing device.

2. The tap hole plug gun according to claim 1, wherein for realizing the form-fitting engagement, a ring segment web is formed on a connecting edge portion on the connecting projection of the nozzle part on the radial interior of the nozzle wall, said ring segment web engaging into a ring segment groove formed on a connecting edge portion on the upper part of the material chamber on the radial exterior of the chamber wall, and/or a ring segment web is formed on a connecting edge portion on the lower part of the nozzle part on the radial exterior of the nozzle wall, said ring segment web engaging into a ring segment groove formed on a connecting edge portion on the connecting projection of the material chamber on the radial interior of the chamber wall.

3. The tap hole plug gun according to claim 1, wherein each connecting edge portion of the nozzle part is provided with a ring segment web extending across essentially the entire length of the connecting edge portion, and each connecting edge portion of the material chamber is provided with a ring segment groove extending across essentially the entire length of the connecting edge portion.

4. The tap hole plug gun according to claim 1, wherein the radially inner ring segment groove formed in the connecting projection of the material chamber extends across a circumferential angle of >180° in such a manner that opposite ring segment groove ends extend in the vertical direction so as to form vertical guides for ends of the ring segment web formed on the connecting projection of the nozzle part.

5. The tap hole plug gun according to claim 1, wherein for realizing the securing device, the connecting projections are detachably connected to each other at opposite horizontal connecting edge portions.

6. The tap hole plug gun according to claim 5, wherein the securing device has two bolt connections disposed on the circumference of the tap hole plug gun in the area of the horizontal connecting edge portions.

7. The tap hole plug gun according to claim 6, wherein the bolt connections serve to connect connecting tabs disposed on a horizontal connecting edge portion of the nozzle part and on a horizontal connecting edge portion of the material chamber, respectively, in a force-fitting manner.

8. The tap hole plug gun according to claim 6, wherein each bolt connection has a bolt and provided with a protective device disposed between the bolt and the mouthpiece and protecting the bolt against external influences.

9. The tap hole plug gun according to claim 8, wherein for realizing the protective device, at least one connecting tab of each bolt connection is provided with a protective web extending parallel to the bolt.

10. The tap hole plug gun according to claim 8 wherein the bolt is a threaded bolt.
